(19) United States
(12) Patent Application Publication
(10) Pub. No.: US 2001/0047337 A1
(43) Pub. Date: Nov. 29, 2001

(54) Individualization wallet

(75) Inventors: Robert Barritz, New York, NY (US); Peter Kassan, New York, NY (US); Gerald Cohen, New York, NY (US)

Correspondence Address: OSTROLENK FABER GERB & SOFFEN, 1180 AVENUE OF THE AMERICAS, NEW YORK, NY, 100368403

(73) Assignee: Isogon Corporation

(21) Appl. No.: 09/809,789

(22) Filed: Mar. 16, 2001

Related U.S. Application Data
(60) Provisional application No. 60/190,149, filed on Mar. 17, 2000.

(51) Int. Cl. G06F 17/60

(52) U.S. Cl. 705/51

(57) ABSTRACT

An Internet related method and process facilitates and streamlines obtaining or purchasing products or information by creating a so-called individualization wallet (IW) which has such components as a repository, which is a database of personal and preference information and related components such as a security controller, an inference engine and a request processor. When one desires to make a purchase all he or she need to do is provide a reference to the repository location where all the preference and personal information is stored and that information is automatically communicated in standardized formats, obviating the need for repeatedly keying personal and preference information.

### RELATED APPLICATION

This Application claims priority and is entitled to the filing date of U.S. Provisional Application Ser. No. 60/190,149 filed Mar. 17, 2000, and entitled “INDIVIDUALIZATION WALLET”, the contents of which are incorporated by reference herein.

### BACKGROUND OF THE INVENTION

The present invention is generally directed to electronic commerce and, more particularly, to a method that facilitates and speeds up the process of accessing e-commerce websites, which require the entry of personal information.

Individuals, viewed as purchasers and consumers of goods and services through the Internet, are distinctive. Each person has particular preferences, aversions, and dimensions that, if known and made available to, for example, a retail clothing website, could be used to guide the selection and sizing process.

Currently, online shopping generally requires an individual to simply key in the appropriate data when requested. If the consumer decides to shop for the same item on another website, he will have to enter much, if not all of, the same information completely over again. To do so each time one shops online would become time-consuming and repetitive.

Some websites use “cookies” or keep a record of a consumer's preferences to eliminate the need to re-enter information every time the consumer visits the site. However, such information is generally specific to that site and cannot be shared among other websites. As a result, the consumer still needs to spend time needlessly and repetitively entering personal information.

### SUMMARY OF THE INVENTION

Accordingly, it is an object of the present invention to provide a system and method which facilitates information searches on the Internet.

It is another object of the invention to provide a system and method which avoids on-line shoppers having to repeatedly key personal and shopping preference information.

It is yet another object of the invention to provide a secure repository of personal information on the Internet.

The foregoing and other objects of the invention are realized with a system and method which provides a plurality of components that can be used together to achieve the objects of the invention. These components include an Individualization Wallet (IW) which acts as a repository for personal preferences, such as colors, patterns, fabrics, styles, etc., and which operates with a Security Controller (IWSC) which is a software process through which requests or access to information is routed and/or handled. A Direct Capture process (IWDC) is operative to capture and store information into the repository to create the original information or to update/modify it. Other components such as the IW Inference Engine (IWIE), the IW Request Processor (IWRP) and Individual Best Fitter (IBF) serve such functions as to provide analysis and inferences about user's preferences, process requests for information and choose information that is best tailored to specific requests.

Other features and advantages of the present invention will become apparent from the following description of the invention which refers to the accompanying drawings.

### BRIEF DESCRIPTION OF THE DRAWINGS

FIG. 1 diagrammatically illustrates the IWR records in a hierarchical arrangement.

FIG. 2 illustrates the IW repository request process.

FIG. 3 diagrammatically illustrates the third party IW repository request process.

FIG. 4 diagrammatically illustrates the process of using IW preference information.

FIG. 5 is a block diagram of the system of the present invention.

### DETAILED DESCRIPTION OF THE INVENTION

The Individualization Wallet (IW) acts as a repository for personal preferences such as: color, pattern, fabric and styles, and size information; individual characteristics such as: birthday, gender, hair, eye and skin color, allergies, pierced ears, language spoken, marital status, number, age and gender of children, religion, profession, hobbies, musical tastes, political alignment; and financial information such as credit and debit card accounts.

The IW repository is under the control of the individual to whom it pertains, whether it exists on that individual's computer or another computer. But, unlike cookies, which contain idiosyncratic information created by a variety of websites, with whatever meaning, and in whatever format they choose, the information in the IW is standardized, accessible and interpretable by any website which the user so authorizes.

The present invention consists of the following components:

IW Repository (IWR): The IWR is a database of personal preference information categorized by the type of data it contains. The IWR and each record or group of records contained therein has a user-specified privacy controls which are used to allow access to specific individuals and organizations (Vendors). Typically, such access is the ability to add, delete, or change records; restrict to read-only access; provide censored abstracts of the data; or to prohibit any access at all.

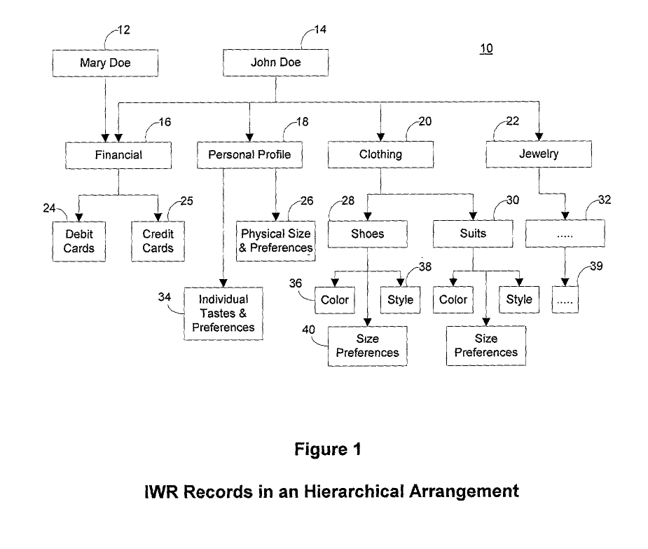

In one embodiment, the personal preference information in the IW is categorized in a hierarchical arrangement (FIG. 1). In this manner, such information is organized in a manner that is meaningful to the user and for which a privacy level is easily established. Cross referencing of certain categories is also permitted for information that is “shared” among family members, such as financial information.

IW Security Controller (IWSC): The IWSC is a software process, operative on the user's computer, a remote computer or a website, that provides various levels and types of privacy protection and security of the data contained within the IWR. All requests to access or change data within the IWR are administered and validated by the IWSC which in turn either grants or denies access to the IWR in accordance to user-specified controls. The IWSC security controls and features can include any of the following:

1. Access to the IW by anyone other than the user (or designated user) requires the vendor to select the user by specifying a user-identification code, alias, or other identifier, and not the user's real name.

2. Access requires a PIN, password or other code to be entered by the user

3. Anonymity—The user's identity (name, address, financial information, etc.) is not disclosed until a sales transaction is consummated, and then only that information that is required to complete the transaction.

4. Access rights—read, write, modify, delete. Selectable by the user and given to a single vendor or set of vendors.

5. Encrypted repository—The IWR is encrypted to prevent unauthorized access to the IWR and the decoding of copies made for the purpose of backing up the data. Such encryption can be applied to the entire repository, to user-specified vendor records, or to arbitrarily user-selected records.

6. IW information that is stored on a vendor system requires the user to supply a PIN, password or other code prior to that data being made available to the vendor.

7. The vendor has rights to only view data that it has stored in the IWR, and not that of other vendors.

8. The vendor must be certified or designated by user. The vendor may have its own access password, use data encryption technology and/or possess a digital certificate.

9. The user can establish time limited rights to a vendor in addition to any other controls already established for that vendor. Such rights can be specified as any or all of a start date and time, end date and time, or duration.

10. Categories—The user can specify one or more vendors to belong to one or more of a pre-defined/user-defined set of categories (e.g., Men's clothing, Women's clothing, Shoes, etc.). Any of the previously described security controls that are applied to a specific category will automatically be established as default controls for each vendor in this category. optionally, the user may specify that these controls override any controls previously set for the vendors in this category.

11. Class of vendors—The user can specify one or more vendors to belong to one or more of a user-defined set of vendors, for example, a user's favorite vendors in a particular shopping mall. Any of the previously described security controls that are applied to a specific class will automatically be established as default controls for each vendor in this class. Optionally, the user may specify that these controls override any controls previously set for the vendors in this class.

12. The IWSC maintains an activity log detailing vendors making requests and their disposition. Additional security measures can include encrypted communications in combination with a “trusted agent” on the Vendor's system. A trusted agent is a software process that is distributed to vendors specified by the user. The agent is a means of secure communications with the IW. Any information retrieved from the IWR by the agent is provided to the Vendor's system in accordance with the transaction being performed. Optionally, the agent inhibits the vendor from storing or using this information if the current transaction is not consummated.

IW Direct Capture (IWDC): The IWDC is a software process, operative on the user's computer, a remote computer or a website, that accepts data directly from the user and incorporates it into the IWR as well as providing the user the ability to view and modify existing data.

IW Inference Engine (IWIE): The IWIE is a software process that analyzes the user's purchases and transactions in order to derive preferences and other information to be incorporated into the IWR. Optionally, the IWIE derives preferences and other information to incorporate into the IWR by analyzing other electronic activities conducted by the user. When the IWIE is active, however, the user has the option of indicating that preferences expressed during a particular interaction do not override preferences already recorded so that, for example, when the user buys a shirt as a present it doesn't wipe out the user's own measurements.

IW Request Processor (IWRP): The IWRP is a software process that receives requests for information, either specifically or by category, from another process operating on behalf of a remote website or computing facility (RW). The IWRP extracts, according to the user's privacy levels administered by the IWSC, the requested information from the IWR and supplies it to the RW.

Optionally, and under user control, the IWRP responds to unsolicited requests for preference data from authorized advertisers, market research firms, etc. and make available the requested data for the purpose of conducting marketing research. The IWRP may maintain a log of such activity for the user to review.

Individual Best Fitter (IBF): Many retail websites sell clothing that must be sized to the individual. Some is custom made to the buyer's measurements, but most is simply supplied from a range of stock sizes. Clothing purchases are further complicated due to the fact that it is common for garments from some manufacturers to run narrow, long, small, full-cut, etc. In any case, the size information contained in the IWR is useful to these e-tailers. But as a related feature of the invention, the Individual Best Fitter (IBF) determines, using artificial intelligence procedures such as neural networks or Fuzzy Logic, the best match between the purchaser's set of size information and the available stock sizes of a particular garment. Typically, the IBF is a process operative at the e-tailer's website, however, it need not be so limited.

Any or all of these components may exist on either the user's computer, or on a remote computer or server.

Hereinafter, website is meant to refer to an Internet website, a computer server, a remote computing facility or computing process operative on the user's computer or the like.

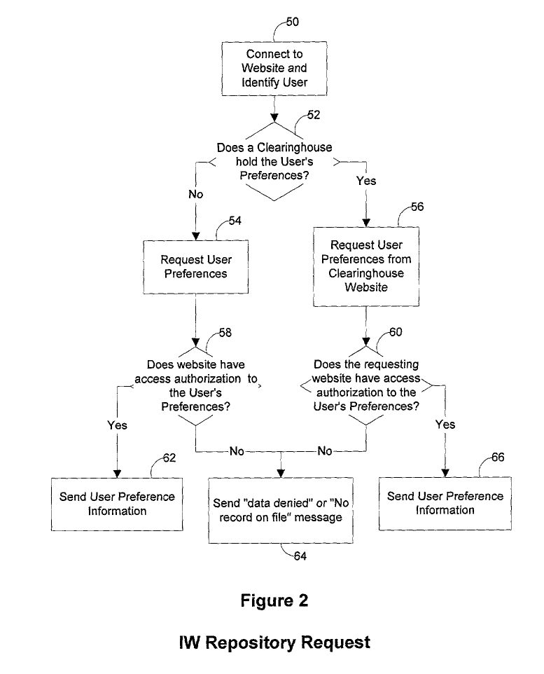

When the individual connects to a website capable of interacting with the IW, the website obtains the individual's identity and makes an automated request to the IWRP to retrieve applicable information from the IWR to the website (FIG. 2). The actual format of the data that is exchanged is one that is mutually understood by the requesting website and the IWRP. Extended Markup Language (XML) is one such format that is suitable.

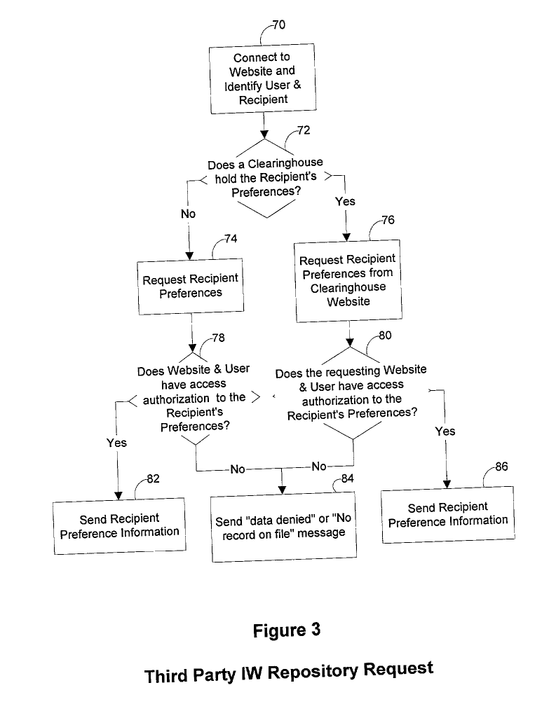

Typically, the repository is resident on the individual's computer and the IWRP is a process that executes on the individual's computer. In one embodiment, the repository and IWRP are contained on another website that acts as a central clearinghouse for such information. When the individual has identified himself, the website will request and receive the IW preferences from the clearinghouse website. (FIG. 2) Optionally, another individual is permitted to use the first individual's IW in a transaction. As the individual is not directly engaged in the transaction, the IWIE does not analyze the purchases. For example, an individual with an upcoming birthday might allow her mother-in-law to use her IW when shopping for a gift, thereby decreasing the odds that the gift will have to be returned. Note that this does not give access to the information in the IWR to others, only the right for the IWRP to supply information directly to e-tailors from the IWR (FIG. 3).

A natural consequence of the system of the present invention is that it allows a third party initiated electronic transactions. For example, an entity may allow a section of its repository relating, for example, to its car insurance to be publicly available. Insurance policy vendors then would have access to this information where they would be able to view all of the personal information on particular individual's insurance needs including for automobiles, homes, etc. and provide bids to supply that insurance. This of course, can relate to other types of insurance such as health care as well as to car leases or to supply certain products, for example, food. Thus, a large organization, for example, a school, may have in its repository, information that it requires a given number of gallons of milk every month and milk vendors can then simply view this information and bid against one another for the business of the school.

As a general note, the individual's or entity's identity need not be disclosed as all of the information in the repository can be supplied through a third party with the vendor having all of the preference information but no more than a identity code which is known only to the intermediary and not to anybody else. Similarly, this system is set up in such a way that the intermediary organization, which can be a central clearinghouse, is not privy (through appropriate encryption of information and selective access to data of any transaction in any given account). It is only knowledgeable about the identity of the account holder. The encrypted communication, including private and public use is only known to those who need to execute the actual e-commerce transactions.

Not all preference information is provided to a website. For example, a website selling men's shirts might request the information pertaining to color preferences (likes blue, hates pink), pattern preferences (likes stripes, doesn't like plaid), style preferences (likes point or button-down collars, doesn't like tab or spread collars), fabric preferences (likes cotton, doesn't like polyester), as well as certain size information (neck, chest and arm measurements).

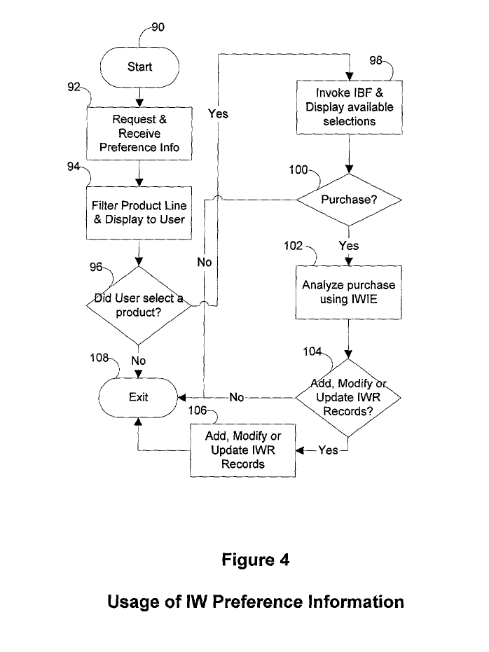

These preferences might then be used by the website, separately or in combination with the IBF, to automatically filter the merchandise displayed or presented to the individual, omitting any items that do not match the preference criteria (FIG. 4). Additionally, items that are out of stock and back-ordered (e.g., a shirt matching the individual's size) can be displayed with that status noted. For any items the individual decides to purchase, the size information might then be used either to make custom garments, if that is offered, or alternatively to find the best fitting match from among the available stock sizes.

To illustrate the importance of the IBF, the following table relates the stock shirt sizes of a particular retailer (Joseph Bank) to the dimension range-for each key measurement-that each size is meant to accommodate.

| Size | S | M | L | XL | XXL |
|---|---|---|---|---|---|
| Neck | 14-14½ | 15-15½ | 16-16½ | 17-17½ | 18-18½ |
| Chest | 34-36 | 38-40 | 42-44 | 46-48 | 50-52 |
| Waist | 28-30 | 32-34 | 36-38 | 40-42 | 44-46 |
| Reg sleeve len | 32-33 | 33-34 | 34-35 | 35-36 | 36-37 |
| Tall sleeve len | 33-34 | 34-35 | 35-36 | 36-37 | 37-38 |

If a 5′11″ individual having a neck size of 15½, a chest of 41, a waist of 35, and a sleeve measurement of 35, wishes to purchase a shirt, it is not immediately clear whether that individual should receive a Medium or a Large, since some of the individual's measurements fall into each range. The IBF would match the individual's measurements to those sizes available in order to determine the best fit.

With specific reference to the drawings, FIG. 1 is a block diagram of records repository 10 and the hierarchical arrangement of records therein. In the example provided, individuals 12 and 14 have their information organized according to such classifications as financial 16, personal profile 18, clothing 20 and jewelry 22. The financial category can contain information about debit cards 24 and credit cards 25. Personal profile information can be organized in sub categories of physical size & preferences 26 and individual tastes and preferences 34. Clothing 20 can be sub classified in accordance with various clothing articles such as shoes 28 and suits 30 and further sub classified in accordance with color 36, style 38 and size preferences 40. The sub categories 32 and 39 which are associated with the jewelry class 22 are left blank to indicate that any classification and sub classification and further refined classifications are possible.

With reference to FIG. 2, the repository request process may begin with the step of connecting to a web site and identifying the user as indicated at step 50, followed by querying whether a clearinghouse holds the user's preferences as indicated at 52. If yes, step 56 indicates that the user's preferences are requested from the clearinghouse website, followed by the query whether the requesting website has access or authorization to the user's preferences as shown at step 60. If yes, the preference information is transmitted as indicated at 66 and if no, a “data denied” response is sent.

Alternatively, step 52 is followed by step 54 which requests user preferences and the subsequent query 58 whether access or authorization has been provided. In no, the program proceeds to step 64. Otherwise, the user preference information is sent as indicated at step 62.

A similar process for a third party repository request is illustrated in FIG. 3. Connection to the website is at step 70 followed by the query regarding the clearinghouse at 72. Steps 76, 80, 86 and 84 correspond to the steps 56, 60, 66 and 64, respectively, of FIG. 2. Similarly, the steps 74, 78 and 82 of FIG. 3, correspond to the respective steps 54, 58 and 62 of FIG. 2.

Referring now to FIG. 4, usage of preference information follows a process that starts at 90 followed by step 92 which requests and receives preference information. Product line is filtered and displayed to the user at step 94. If a user selected a product at step 96, the IBF process is invoked at step 98 to display available selections. If a purchase has been indicated, it is analyzed using the inference engine at step 102 and any modifications or additions are effectuated by carrying out steps 104, 106. Otherwise the program exits at step 108.

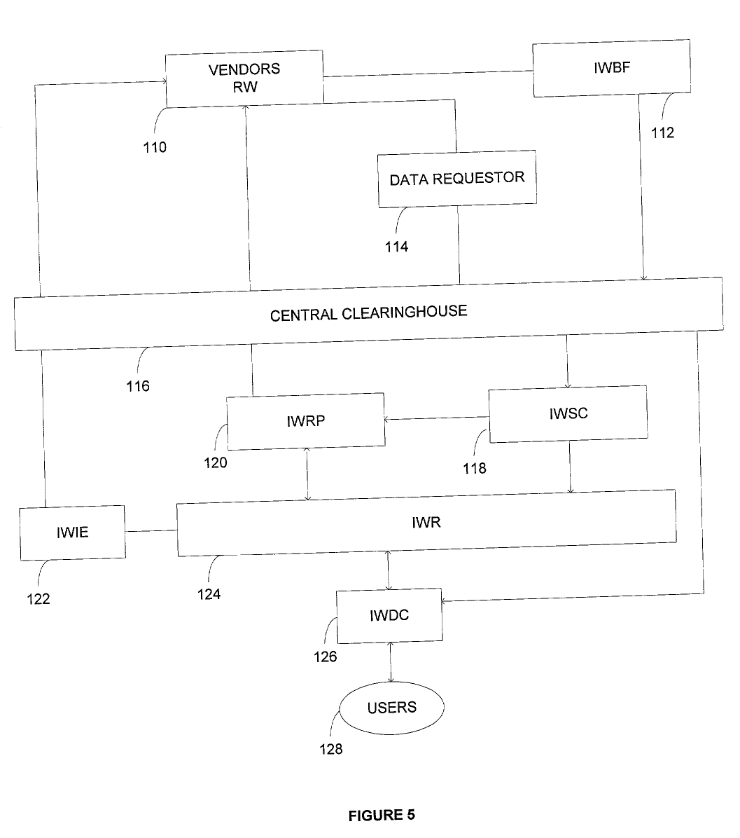

FIG. 5 is a generalized block diagram of certain components of the invention including the vendors 110, communicating or operating with the best fitter facility 112 and the data requester 114. Information can flow directly toward the users or it may be channeled through the optional central clearinghouse 116. Information exchange can be open or it can proceed through the security controller 118, and similar information from the repository 124 can be exchanged directly with the vendors 110 or through the request processor 120. FIG. 5 also shows the inference engine 122. Users 128 communicate with a repository 124 via the direct contact facility 126.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A system for facilitating electronic commerce, the system comprising:
a repository storing data including personal and preference data, the personal and preference data having a standardized predetermined organization, the data and information pertaining to a corresponding user;
a direct contact facility that enables the user to communicate with the repository to enter or view the data and/or related control information; and
a data requester serving as an intermediary between a plurality of product vendors and information requesters, the data requester receiving requests for information and supplying data from the repository that is applicable to contemplated transactions.

2. The system of claim 1, in which the repository is a database of personal preference information categorized by the type of data it contains.

3. The system of claim 1, including in the repository user-specified privacy controls.

4. The system of claim 1, in which personal data and preference information are categorized in a hierarchical arrangement.

5. The system of claim 1, in which the data in the repository contains cross-referencing information.

6. The system of claim 1, further including a security controller that provides various levels and types of privacy protection and security of the data contained within the repository.

7. The system of claim 6, in which the security controller grants or denies access to the information in the repository in accordance with user specified controls that are selected from the group consisting of:
a) user-identification codes;
b) a personal identification number;
c) a partial access to information;
d) pre-identified data requester;
e) restriction of the type of data available to each requester;
f) time limited rights; and
g) categories of vendors.

8. The system of claim 7, in which the security controller includes a facility which maintains an activity log detailing parties making requests and their disposition.

9. The system of claim 1, in which the information in the repository is partially or wholly encrypted.

10. The system of claim 1, further comprising a trusted agent facility through which all communication with the repository must be conducted.

11. The system of claim 1, including a direct capture facility that is operative through a remote computer or a website that accepts data directly from the user and incorporates it into the repository.

12. The system of claim 1, further including an inference engine that analyzes a user's purchases and transactions and derives inferred preferences therefrom and stores the inferred preferences in the repository.

13. The system of claim 1, further including an individual best fitter facility that is operable to associate personal and preference data of a given user to corresponding product specifications of vendors.

14. The system of claim 13, in which the individual best fitter incorporates artificial intelligence procedures to create the associations.

15. The system of claim 1, in which the repository and data requester are operable on a user's own computer.

16. The system of claim 1, in which the user is an entity selected from a group consisting of: an individual, a family, a household, a business, and an organization.
